(19) United States
(12) Patent Application Publication
(10) Pub. No.: US 2016/0342288 A1
(43) Pub. Date: Nov. 24, 2016

(54) INTELLIGENT HIGHLIGHTING OF ITEM LISTING FEATURES

(71) Applicant: eBay Inc., San Jose, CA (US)

(72) Inventors: Tolga Konik, Menlo Park, CA (US); Jason Allen Fletchall, San Jose, CA (US); Aravind Ragipindi, Sunnyvale, CA (US); Patrick Cheung, San Jose, CA (US)

(21) Appl. No.: 14/985,018

(22) Filed: Dec. 30, 2015

Related U.S. Application Data
(60) Provisional application No. 62/163,900, filed on May 19, 2015.

(51) Int. Cl. G06F 3/0482; G06F 17/30; G06Q 30/06; G06F 3/0484

(52) U.S. Cl. CPC G06F 3/0482; G06F 3/04842; G06F 17/3053; G06Q 30/0643; G06Q 30/0627

(57) ABSTRACT

Systems and methods of highlighting item listing features are disclosed. In some example embodiments, a request to display a first item listing on a computing device of a user is detected, with the first item listing having a plurality of features, and at least one feature from the plurality of features is selected based on user information associated with the user, in response to the detecting the request. The selected feature(s) is caused to be highlighted in a display of the first item listing on the computing device, with the highlighting of the selected feature(s) comprising at least one of displaying the selected feature(s) instead of the unselected ones of the plurality of features and applying a visual effect to the selected feature(s), with the application of the visual effect being distinct from a presentation of the unselected ones of the plurality of features.

### CROSS-REFERENCE TO RELATED APPLICATIONS

This application claims the benefit of priority, under 35 U.S.C. Section 119(e), to U.S. Provisional Application No. 62/163,900, filed on May 19, 2015, entitled, “INTELLIGENT HIGHLIGHTING OF ITEM LISTING FEATURES”, which is hereby incorporated by reference in its entirety as if set forth herein.

### TECHNICAL FIELD

Embodiments of the present disclosure relate generally to data processing and, more particularly, but not by way of limitation, to systems and methods of intelligent highlighting of item listing features.

### BACKGROUND

Certain computing devices, particularly mobile devices, suffer from limited screen space. As a result, the presentation of a large amount of content may cause difficulty for a user in consuming information, thus leading to a negative user experience.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a networked system, in accordance with some example embodiments.

FIG. 2 is a block diagram illustrating various components of a network-based publication system, in accordance with some example embodiments.

FIG. 3 is a block diagram illustrating various tables that can be maintained within a database, in accordance with some example embodiments.

FIG. 4 is a block diagram illustrating a feature highlighting system residing on a mobile device, in accordance with some example embodiments.

FIG. 5 is a block diagram illustrating components of a feature highlighting system, in accordance with some example embodiments.

FIG. 6 is a block diagram illustrating inputs and outputs of a feature selection module, in accordance with some example embodiments.

FIG. 7 illustrates a user interface (UI) displaying an item listing with highlighted features, in accordance with some example embodiments.

FIG. 8 illustrates UI's displaying an item listing at different stages of a user's experience in interacting with an item listing, in accordance with some example embodiments.

FIG. 9 illustrates a UI displaying multiple item listings with highlighted features, in accordance with some example embodiments.

FIG. 10 illustrates a UI displaying multiple item listings with features, in accordance with some example embodiments.

FIG. 11 illustrates a UI displaying multiple item listings with features, in accordance with some example embodiments.

FIG. 12 is a flowchart illustrating a method of highlighting features of an item listing, in accordance with some example embodiments.

FIG. 13 is a block diagram illustrating a mobile device, in accordance with some example embodiments.

FIG. 14 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

The present disclosure provides technical solutions for highlighting one or more features of one or more item listings. These technical solutions provide an efficient use of resources of a computing device, including screen space and load processing.

In some example embodiments, a system uses intelligence to determine what features of an item listing to display, stand-out, or otherwise highlight. A feature of an item listing comprises any information or data corresponding to the item listing. Types or categories of features include, but are not limited to, shipping features, return policy features, seller features, quantity features, price features, and other item features. Other types or categories of features include detailed product-related features. Such detailed product-related features comprise details about a product itself (e.g., screen size, color, memory, resolution). Other types of features are also within the scope of the present disclosure.

Each type of category of features comprises multiple features. Examples of shipping features include, but are not limited to, free-shipping, overnight delivery, and the like. Examples of return policy features include, but are not limited to, 30-day guaranteed money back returns, 60-day guaranteed money back returns, and the like. Examples of seller features include, but are not limited to, longtime member, 100% (or other percentage or measurement) positive feedback, and the like. Examples of quantity features include, but are not limited to, number of the corresponding items of the item listing that have been sold, number of the corresponding items of the item listing that are still available, and the like. Examples of price features include, but are not limited to, sales price, reduction in sales price, and the like. Examples of other item features include, but are not limited to, sale of the corresponding item being directed to a charity, condition of the corresponding item, and the like.

In some example embodiments, the techniques disclosed herein are employed in a single-item context, such as in a view item page, where the system uses information about the user engaged in the single-item context (e.g., browsing history, purchasing history, etc.) to determine what features (e.g., free shipping, 30-day money back guarantee, seller rating) of the corresponding item listing being viewed to highlight.

In some example embodiments, the techniques disclosed herein are employed in a multi-item context, such as in a search results page, where the system determines what features of each item listing in the search results to highlight. Certain features can be highlighted for certain item listings in the results list, while other features can be highlighted for other item listings in the results list. In some example embodiments, the determination of which features of an item listing to highlight is based on any combination of one or more of user information (e.g., browsing history, purchasing history, in-session behavior and context) of the user for which the determination of the features is being made, item information (e.g., category, price, sale type, variance in features between different item listings being displayed), and feature constraints (e.g., restriction on the number of features that can be displayed concurrently for an item listing, restriction on the number of features of a single grouping that can be displayed concurrently for an item listing).

In some example embodiments, at least one processor detects a request to display a first item listing on a computing device of a user, with the first item listing having a plurality of features, and the processor(s) selects at least one feature from the plurality of features based on user information associated with the user, in response to the detecting the request. In some example embodiments, the processor(s) causes the selected at least one feature to be highlighted in a display of the first item listing on the computing device based on the selecting of the feature(s), with the highlighting of the selected at least one feature comprising at least one of displaying the selected at least one feature instead of the unselected ones of the plurality of features (e.g., highlighting selected feature, while suppressing/hiding unselected features) and applying a visual effect to the selected at least one feature (e.g., to make it more visibly noticeable than unselected features that are concurrently displayed), with the application of the visual effect being distinct from a presentation of the unselected ones of the plurality of features.

In some example embodiments, the highlighting of the selected at least one feature comprises applying the visual effect to the selected at least one feature, with the visual effect comprising at least one of a distinct color, a distinct font, a distinct boldness level, a rectangular graphical element, and a circular graphical element.

In some example embodiments, the user information comprises at least one of a geographic location of the user, an age of the user, a gender of the user, a browsing history of the user, a purchasing history of the user, and a purchasing funnel position corresponding to the request to display the first item listing.

In some example embodiments, a system of the present disclosure determines and analyzes the differences between item listings, and determines which features of each item listing to highlight based on these differences. In some example embodiments, the selecting of the feature(s) from the plurality of features is further based on a degree of variance between the selected feature(s) and a corresponding at least one feature of at least one item listing other than the first item listing, with the corresponding feature(s) being of the same type as the selected feature(s). In some example embodiments, the item listing(s) other than the first item listing is displayed on the computing device concurrently with the first item listing being displayed on the computing device with the selected feature(s) highlighted. In some example embodiments, the item listing(s) other than the first item listing and the first item listing are displayed concurrently on a search results page of an online service. In some example embodiments the item listing(s) other than the first item listing and the first item listing are displayed concurrently in an e-mail message or in a web widget.

In some example embodiments, the selecting of the feature(s) from the plurality of features comprises determining corresponding scores for each of the plurality of features using a model, ranking the plurality of features based on their corresponding scores, and selecting the at least one feature based on the ranking. In some example embodiments, user activity information indicating at least one action performed for the first item listing by the user is received, with the action(s) corresponding to the display of the highlighted selected at least one feature, and the model is updated based on the received user activity information.

The methods or embodiments disclosed herein can be implemented as a computer system having one or more modules (e.g., hardware modules or software modules). Such modules can be executed by one or more processors of the computer system. The methods or embodiments disclosed herein can be embodied as instructions stored on a machine-readable medium that, when executed by one or more processors, cause the one or more processors to perform the instructions.

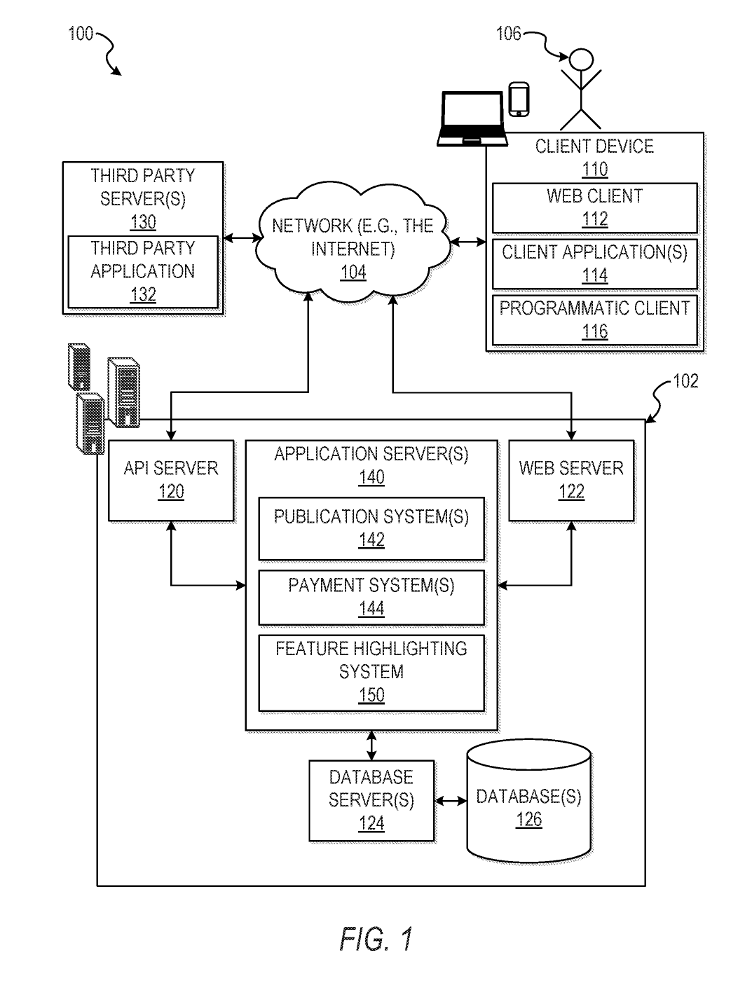

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142, payment systems 144, and feature highlighting system 150, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The feature highlighting system 150 provides functionality operable to perform various feature highlighting operations, as will be discussed in further detail below. The feature highlighting system 150 may access the data from the databases 126, the third party servers 130, the publication system 142, and other sources. In some example embodiments, the feature highlighting system 150 may analyze the data to perform feature highlighting operations. In some example embodiments, the feature highlighting system 150 communicates with the publication systems 142 (e.g., accessing item listings) and payment system 144. In an alternative embodiment, the feature highlighting system 150 is a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and feature highlighting system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 132, executing on a third party server(s) 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

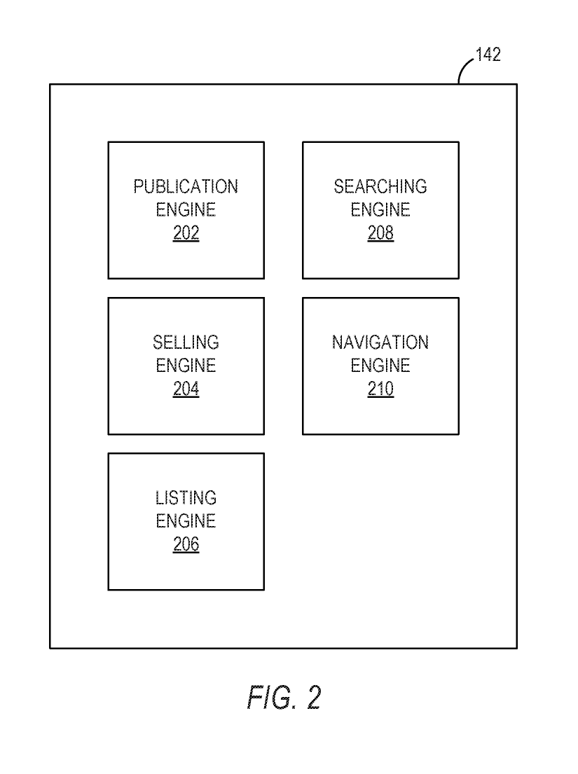

FIG. 2 is a block diagram illustrating various components of the network-based publication system 142, in accordance with some example embodiments. The publication system 142 can be hosted on dedicated or shared server machines that are communicatively coupled to enable communications between server machines. The components themselves are communicatively coupled (e.g., via appropriate interfaces) to each other and to various data sources, so as to allow information to be passed between the components or so as to allow the components to share and access common data. Furthermore, the components can access one or more databases 126 via the database servers 124.

The publication system 142 can provide a number of publishing, listing, and/or price-setting mechanisms whereby a seller (also referred to as a first user) can list (or publish information concerning) goods or services for sale or barter, a buyer (also referred to as a second user) can express interest in or indicate a desire to purchase or barter such goods or services, and a transaction (such as a trade) can be completed pertaining to the goods or services. To this end, the publication system 142 can comprise at least one publication engine 202 and one or more selling engines 204. The publication engine 202 can publish information, such as item listings or product description pages, on the publication system 142. In some embodiments, the selling engines 204 can comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines can also provide a number of features in support of these auction-format listings, such as a reserve price feature whereby a seller can specify a reserve price in connection with a listing and a proxy-bidding feature whereby a bidder can invoke automated proxy bidding. The selling engines 204 can further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the publication system 142. In some embodiments, the listings can be an offer, deal, coupon, or discount for the good or service. Each good or service is associated with a particular category. The listing engine 206 can receive listing data such as title, description, and aspect name/value pairs. Furthermore, each listing for a good or service can be assigned an item identifier. In other embodiments, a user can create a listing that is an advertisement or other form of information publication. The listing information can then be stored to one or more storage devices coupled to the publication system 142 (e.g., databases 126). Listings also can comprise product description pages that display a product and information (e.g., product title, specifications, and reviews) associated with the product. In some embodiments, the product description page can include an aggregation of item listings that correspond to the product described on the product description page.

The listing engine 206 can also allow buyers to conveniently author listings or requests for items desired to be purchased. In some embodiments, the listings can pertain to goods or services that a user (e.g., a buyer) wishes to transact via the publication system 142. Each good or service is associated with a particular category. The listing engine 206 can receive as much or as little listing data, such as title, description, and aspect name/value pairs, that the buyer is aware of about the requested item. In some embodiments, the listing engine 206 can parse the buyer's submitted item information and can complete incomplete portions of the listing. For example, if the buyer provides a brief description of a requested item, the listing engine 206 can parse the description, extract key terms, and use those terms to make a determination of the identity of the item. Using the determined item identity, the listing engine 206 can retrieve additional item details for inclusion in the buyer item request. In some embodiments, the listing engine 206 can assign an item identifier to each listing for a good or service.

In some embodiments, the listing engine 206 allows sellers to generate offers for discounts on products or services. The listing engine 206 can receive listing data, such as the product or service being offered, a price and/or discount for the product or service, a time period for which the offer is valid, and so forth. In some embodiments, the listing engine 206 permits sellers to generate offers from the sellers' mobile devices. The generated offers can be uploaded to the publication system 142 for storage and tracking.

Searching the publication system 142 is facilitated by a searching engine 208. For example, the searching engine 208 enables keyword queries of listings published via the publication system 142. In example embodiments, the searching engine 208 receives the keyword queries from a device of a user and conducts a review of the storage device storing the listing information. The review will enable compilation of a result set of listings that can be sorted and returned to the client device 110 of the user. The searching engine 208 can record the query (e.g., keywords) and any subsequent user actions and behaviors (e.g., navigations).

The searching engine 208 also can perform a search based on the location of the user. A user can access the searching engine 208 via a mobile device and generate a search query. Using the search query and the user's location, the searching engine 208 can return relevant search results for products, services, offers, auctions, and so forth to the user. The searching engine 208 can identify relevant search results both in a list form and graphically on a map. Selection of a graphical indicator on the map can provide additional details regarding the selected search result. In some embodiments, the user can specify as part of the search query a radius or distance from the user's current location to limit search results.

The searching engine 208 also can perform a search based on an image. The image can be taken from a camera or imaging component of a client device or can be accessed from storage.

In a further example, a navigation engine 210 allows users to navigate through various categories, catalogs, or inventory data structures according to which listings can be classified within the publication system 142. For example, the navigation engine 210 allows a user to successively navigate down a category tree comprising a hierarchy of categories (e.g., the category tree structure) until a particular set of listings is reached. Various other navigation applications within the navigation engine 210 can be provided to supplement the searching and browsing applications. The navigation engine 210 can record the various user actions (e.g., clicks) performed by the user in order to navigate down the category tree.

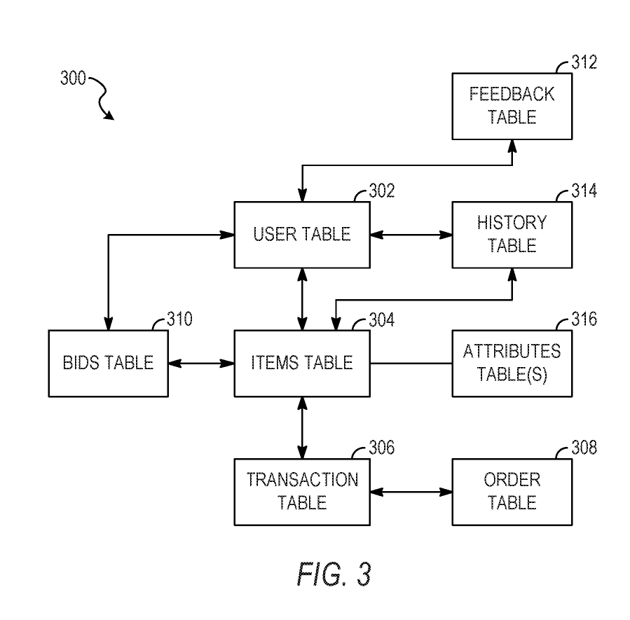

FIG. 3 is a high-level entity-relationship diagram, illustrating various tables 300 that can be maintained within the database(s) 126, and that are utilized by and support the systems 142, 144, and 150. A user table 302 contains a record for each registered user of the networked system 102, and can include identifier, address and financial instrument information pertaining to each such registered user. A user can operate as a seller, a buyer, or both, within the networked system 102. In one example embodiment, a buyer can be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 can furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, can be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 can indicate a currency attribute associated with a particular item, with the currency attribute identifying the currency of a price for the relevant item as specified by a seller.

Although FIG. 1 shows feature highlighting system 150 residing on application server(s) 140, in some example embodiments, feature highlighting system 150 resides on a client device 110. In some example embodiments, when the feature highlighting system 150 resides on the client device 140, the feature highlighting system 150 communicates with one or more systems of the application server(s) 140, such as with the publication system(s) 142 or the payment system(s) 144, as well as with other components of the networked system 102, such as the database(s) 126. Although example embodiments of the present disclosure involve the highlighting of features of item listings of an online marketplace (e.g., an e-commerce site), it is contemplated that the techniques disclosed herein can also be employed in other environments with other types of media, including, but not limited to, advertisements (or other content) around the Web and in broadcasting, multicasting, and unicasting content (e.g., television shows, webisodes).

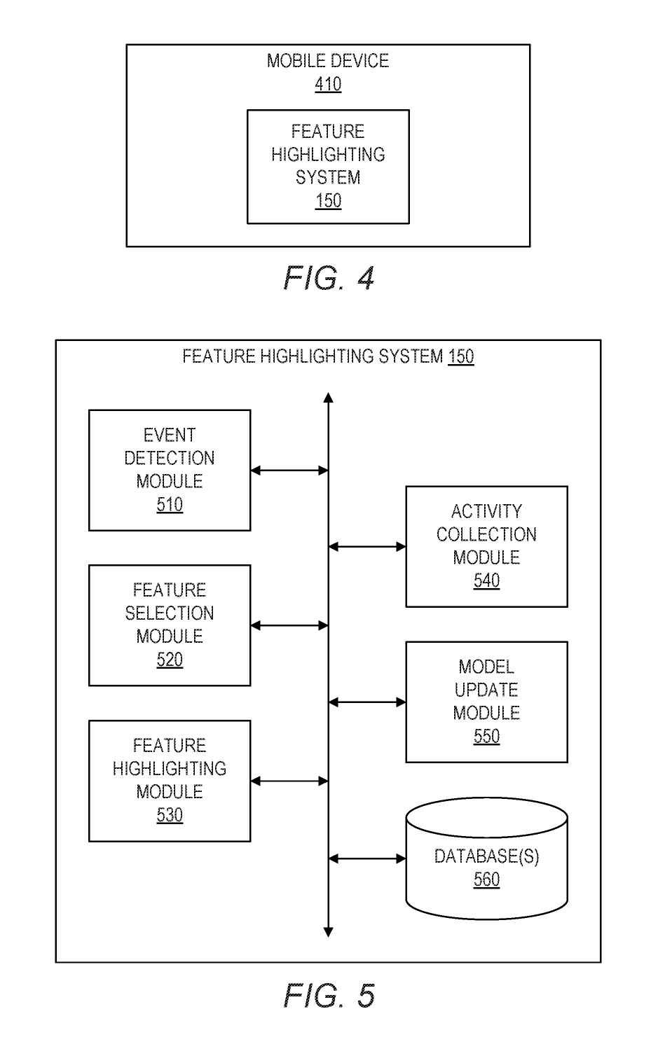

FIG. 4 is a block diagram illustrating feature highlighting system 150 residing on a mobile device 410. Examples of the mobile device 410 include, but are not limited to, a smart phone, a tablet computer, and a wearable computing device. Other types of mobile devices 410 are also within the scope of the present disclosure.

FIG. 5 is a block diagram illustrating components of the feature highlighting system 150, in accordance with some example embodiments. In some example embodiments, the feature highlighting system 150 comprises any combination of one or more of an event detection module 510, a feature selection module 520, a feature highlighting module 530, an activity collection module 540, and a model update module 550. In some example embodiments, the feature highlighting system 150 also comprises one or more databases 560. The event detection module 510, feature selection module 520, feature highlighting module 530, activity collection module 540, model update module 550, and the database(s) 560 are communicatively coupled to each other. In some example embodiments, the event detection module 510, feature selection module 520, feature highlighting module 530, activity collection module 540, model update module 550, and the database(s) 560 reside on a single machines having a memory and at least one processor. In some example embodiments, one or more of the event detection module 510, feature selection module 520, feature highlighting module 530, activity collection module 540, model update module 550, and the database(s) 560 reside on different machines, such as some of these components residing on the application server 140 of FIG. 1, while other of these components reside on the mobile device 410 of FIG. 4. Database(s) 560, or a portion thereof, can be incorporated into database(s) 126 of FIG. 1.

In some example embodiments, the event detection module 510 is configured to detect, or otherwise determine, an event involving one or more item listings (or an event involving online content of another type). In one example, the event detection module 510 detects that a view item page of an item listing is to be displayed to a user of an online service, such as based on a received request (e.g., a click) from the user to view details of an item listing. In another example, the event detection module 510 detects that a search results page or an item comparison page comprising multiple item listings is to be displayed to a user of an online service, such as based on a received request from the user. Other types of events are also within the scope of the present disclosure.

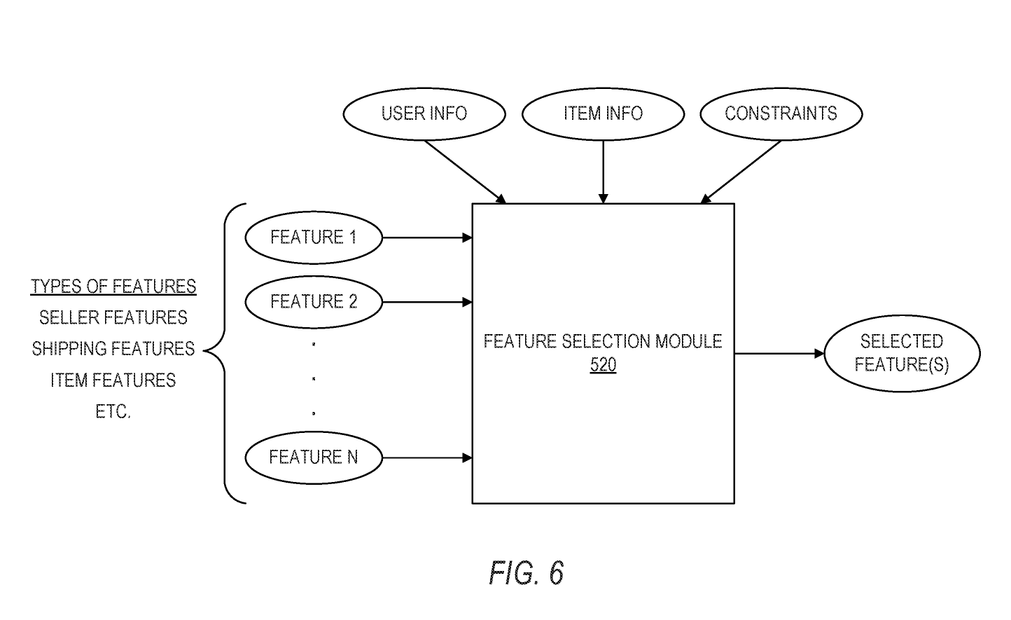

As seen in FIG. 6, in some example embodiments, the feature selection module 520 is configured to select one or more features from a plurality of potential features (e.g., FEATURE 1, FEATURE 2, . . . , FEATURE N) based on any combination of one or more of user information, item information, and feature constraints. As previously discussed, a feature of an item listing comprises any information or data corresponding to the item listing. Types or categories of features include, but are not limited to, seller features, shipping features, item features, return policy features, quantity features, and price features. Other types or categories of features are also within the scope of the present disclosure. Each type or category of feature can have one or more corresponding features. For example, the category of shipping features can have features that include, but are not limited to, free shipping, next day delivery, and worldwide shipping. In some example embodiments, the plurality of features from which the feature selection module 520 selects the feature(s) is provided by the publication system 142 of FIG. 1. However, it is contemplated that other sources of the plurality of features are also within the scope of the present disclosure.

In some example embodiments, the user information comprises any information related to the user for whom the display of the features is being determined. Examples of such user information include, but are not limited to, user profile information (e.g., geographic location, age, gender), the user's browsing history (e.g., what items the user has viewed or placed on a watch list on an online service during a certain time period), the user's purchasing history (e.g., what items the user has purchased on an online service during a certain time period), in-session behavior of the user (e.g., what actions the user has performed or what items the user has viewed during the current session on the online service in which the user is to be presented with the selected features), in-session context of the user's experience on an online service (e.g., what context of the online service the user is currently engaged in at the time or stage at which the selected features are to be presented to the user, such as a browsing items stage, a comparing items stage, and a purchasing item stage), and social media behavior of the user (e.g., what things the user has “liked” or performed other social media actions on), as well as profile information, browsing history, purchasing history, and social media behavior of other people that are determined to have a connection to the user, either by having been determined to be similar to the user (e.g., based on a comparison of user profiles or behavior) or by having a social media connection (e.g., friends that are linked via a social networking service). Other types of user information are also within the scope of the present disclosure.

In some example embodiments, the item information comprises any information of an item or of items for which features are being selected to be highlighted for presentation to the user. Examples of item information include, but are not limited to, category of an item, price of an item, sale type of an item (e.g., auction, fixed-price), and variance in features between different item listings that are to be displayed to the user. Other types of item information are also within the scope of the present disclosure. Additionally, the item information can be listing specific (e.g., information specific to the particular item listing that is presented to the user during the current session) or product specific (e.g., information specific to the particular product corresponding to the particular item that is presented to the user during the current session).

In some example embodiments, the feature constraints comprise any rules that are configured to restrict or filter the features to be presented to the user. One example of a feature constraint comprises a maximum number of features that can be displayed concurrently for an item listing. For example, such a feature constraint can comprise a rule that no more than three features are to be shown for a single item listing. Another example of a feature constraint comprises a maximum number of features of a single grouping (e.g., type or category) that can be displayed concurrently for a single item listing. For example, such a feature constraint can comprise a rule that no more than one feature of a particular feature category is to be presented concurrently for a single item listing (e.g., no more than one seller feature, one shipping feature, one return policy feature, etc.). Other types of feature constraints are also within the scope of the present disclosure.

In some example, the feature selection module 520 is configured to select one or more features from the plurality of features based on one or more of the user information, the item information, and the feature constraint(s) using a model. The model can be used to rank the plurality of features. The feature selection module 520 can then select one or more of the top ranking features (e.g., the top three ranked features) as the selected features to be used in presentation to the user. The model can be updated using machine learning based on subsequent information (e.g., subsequently obtained browsing history information and purchase history information for the user or similar users).

In some example embodiments, any combination of one or more of the item information, the user information, the feature constraints, and the model are stored and retrieved from database(s) 560. However, other configurations are also within the scope of the present disclosure.

Referring back to FIG. 5, in some example embodiments, the feature highlighting module 530 is configured to cause the selected feature(s) from the feature selection module 520 to be highlighted. In some example embodiments, highlighting the selected feature(s) comprises causing the selected feature(s) of an item listing to be displayed instead of other features of the same item listing when displaying the item listing to the user. In other example embodiments, highlighting the selected feature(s) of the item listing comprises causing the selected feature(s) of the item listing to be displayed in a distinguishing fashion compared to other features of the item listing, such as by using a different color, font, or boldness level for the text of the feature, displaying a rectangular graphical element or circular graphical element around the feature, or by applying some other visual effect (e.g., an arrow pointing to the feature, explicit language identifying the importance of the feature) or technique to promote the feature to the user (e.g., make the feature(s) more noticeable to the user than other features). Other types of highlighting of features are also within the scope of the present disclosure.

In some example embodiments, the activity collection module 540 is configured to collect user activity information. This user activity information comprises any information indicating actions performed by the user, such as any actions performed by the user as a result of the selected feature(s) being highlighted. For example, if a user is presented with an item listing having three features highlighted, and the user purchases the corresponding item during the same online session, then an indication of that purchase in association with the three highlighted selected features can be stored in the database(s) 560 as user activity information.

In some example embodiments, the model update module 550 is configured to update the model used by the feature selection model 520 to rank the plurality of features based on the user activity information. The model update module 550 can employ machine learning techniques to reconfigure the model based on the user activity information.

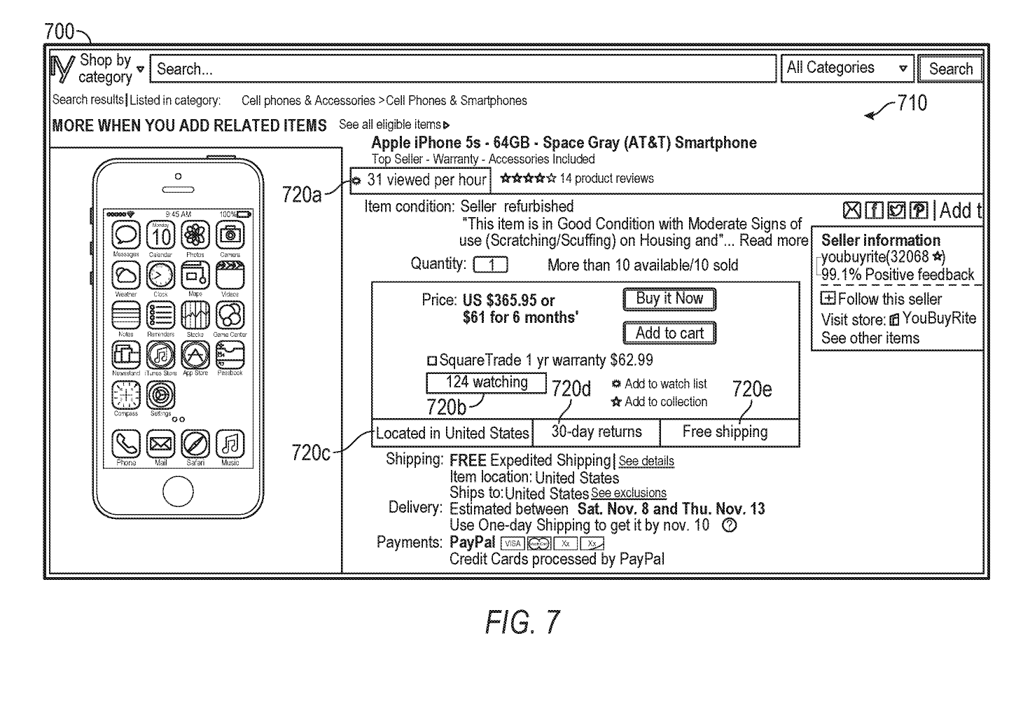

FIG. 7 illustrates a user interface (UI) 700 displaying an item listing 710 with highlighted features 720a, 720b, 720c, 720d, and 720e, in accordance with some example embodiments. The item listing 710 comprises an identification of the corresponding item (e.g., “Apple iPhone 5s—64 GB—Space Gray (AT&T) Smartphone”), an image of the corresponding item, as well as other information associated with the item. Some information (e.g., item identification) can be determined by the feature selection module 520 to be consistently present for item listings, such that features corresponding to such information are automatically displayed to the user without any need for selection by the feature selection module 520. However, other information of an item listing varies from item listing to item listing. In the example shown in FIG. 7, the feature 720a of the item listing having been viewed thirty-one times per hour, the feature 720b of one-hundred and twenty-four users watching the item listing, the feature 720c of the corresponding item (or seller of the item) being located in the United States, the feature 720d of a 30-day return policy for the item listing, and the feature 720e of free shipping for the item listing have all been selected as being sufficiently relevant to the user to trigger their promotion to the user via highlighting.

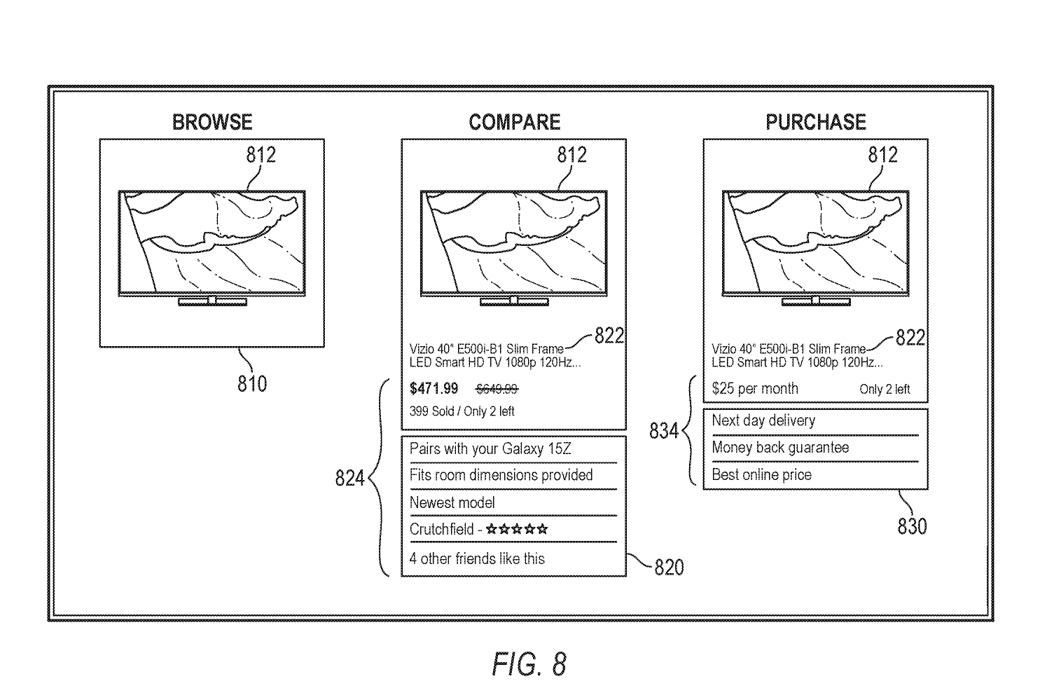

FIG. 8 illustrates UIs 810, 820, and 830 displaying an item listing at different stages of a user's experience in interacting with an item listing, in accordance with some example embodiments. In UI 810, the user is browsing an online service (e.g., an online marketplace) and is presented with an image 812 of an item of an item listing. In UI 820, the user is viewing an item comparison page, where one item listing is being compared to one or more other item listings, with the image 812 of the corresponding item and an identification 822 of the corresponding item are displayed. Based on this context of the user's experience, the feature selection module 520 can select what features 824 to highlight. Since the user is in a comparison context, features that help distinguish the item listing from other item listings at that particular stage in the conversion funnel can be promoted (e.g., what items of the user the item of the item listing pairs with, the fact that the item fits the dimensions of a particular room of the user, the fact that the item of the item listing is of the newest model of the corresponding product, a rating of the seller of the item listing, an indication that friends of the user like the item or product of the item listing). In UI 830, the user is further down the line in the conversion funnel, such as at a stage just before purchase. Here, in addition to the image 812 and the identification 822 of the item listing, additional features 834 of the item listing are highlighted. The features 834 have been determined to be most relevant to the user for this particular stage of the user's online experience (e.g., financing options, next day delivery feature, money back guarantee, best online price).

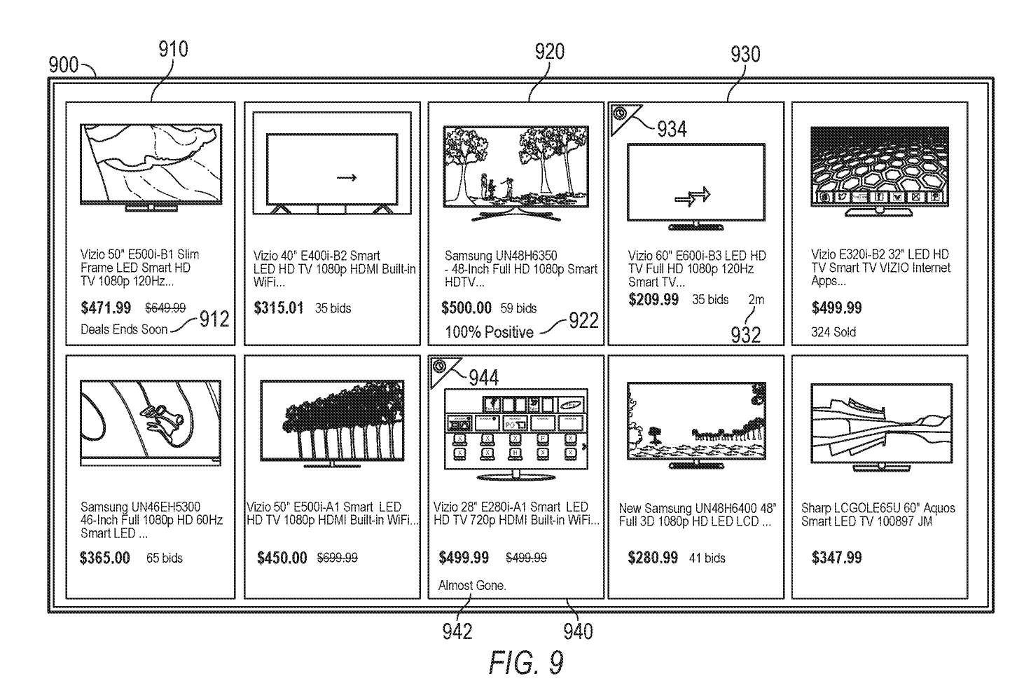

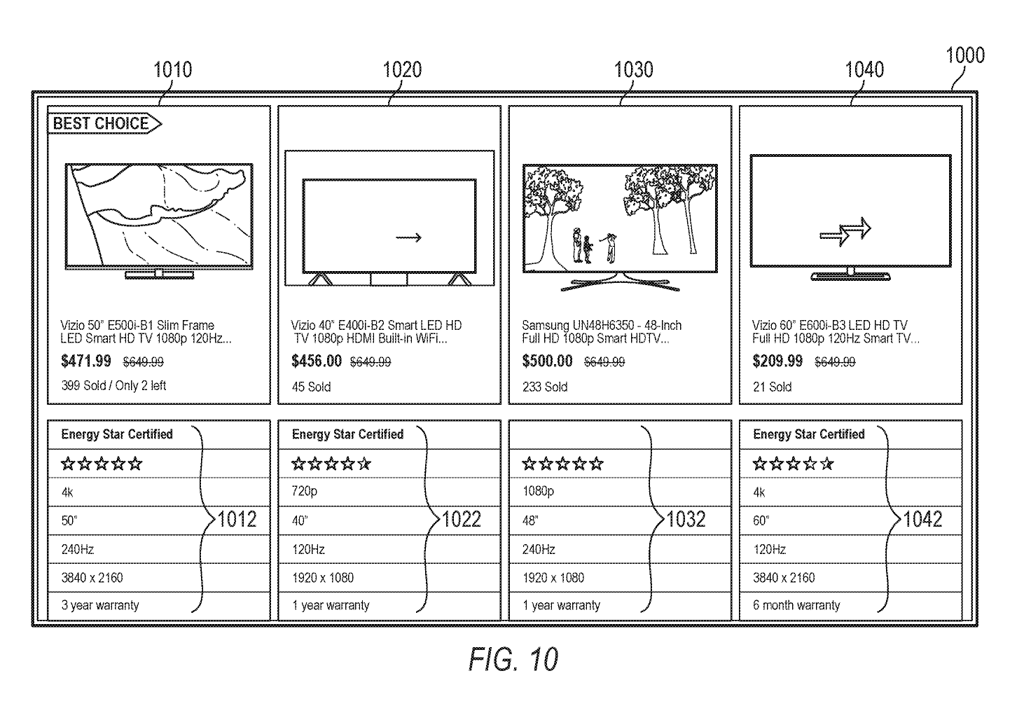

FIG. 9 illustrates a UI 900 displaying multiple item listings, such as item listings, 910, 920, 930, and 940, with highlighted features, in accordance with some example embodiments. The multiple item listings are displayed concurrently to the user, such as part of a search results page, a promotion landing page, or in an e-mail or a web widget (e.g., a merchandizing web widget) to the user. As seen in FIG. 9, although certain information is consistently displayed for each item listing (e.g., image, identification, price), other information is selected as a unique relevant feature of certain item listings and is highlighted as such. For example, item listing 910 comprises a highlighted feature 912 of the reduced price of the item ending soon. Item listing 920 comprises a highlighted feature 922 of the corresponding seller having a 100% positive feedback rating. Item listing 930 comprises a highlighted feature 932 of 2 minutes remaining in the corresponding auction for the item listing. Item listing 940 comprises a highlighted feature 942 of the supply of the corresponding item almost being gone.

FIG. 10 illustrates a UI 1000 displaying multiple item listings 1010, 1020, 1030, and 1040 with features 1012, 1022, 1032, and 1042, respectively, in accordance with some example embodiments. In some example embodiments, the feature selection module 520 is configured to select features to highlight based on a consideration of variance among the features of the multiple item listings that are to be presented to the user concurrently. In this respect, the feature selection module 520 can determine to select to highlight the features of each item listing that distinguish that item listing from the other item listings, with variance among features between item listings being weighted greater in the model for ranking the features. For example, if all or a significant number (e.g., more than half) of the multiple item listings have the same feature (e.g., 30-day return policy), then that feature is less likely to help distinguish the item listings from one another, and would thus be a waste of resources (e.g., screen space, processing power) to highlight. In FIG. 10, the features determined to be the most unique for each item listing, as well as the features determined to be the most relevant to the user, are highlighted (e.g., displayed in bold, as opposed to a lighter shade).

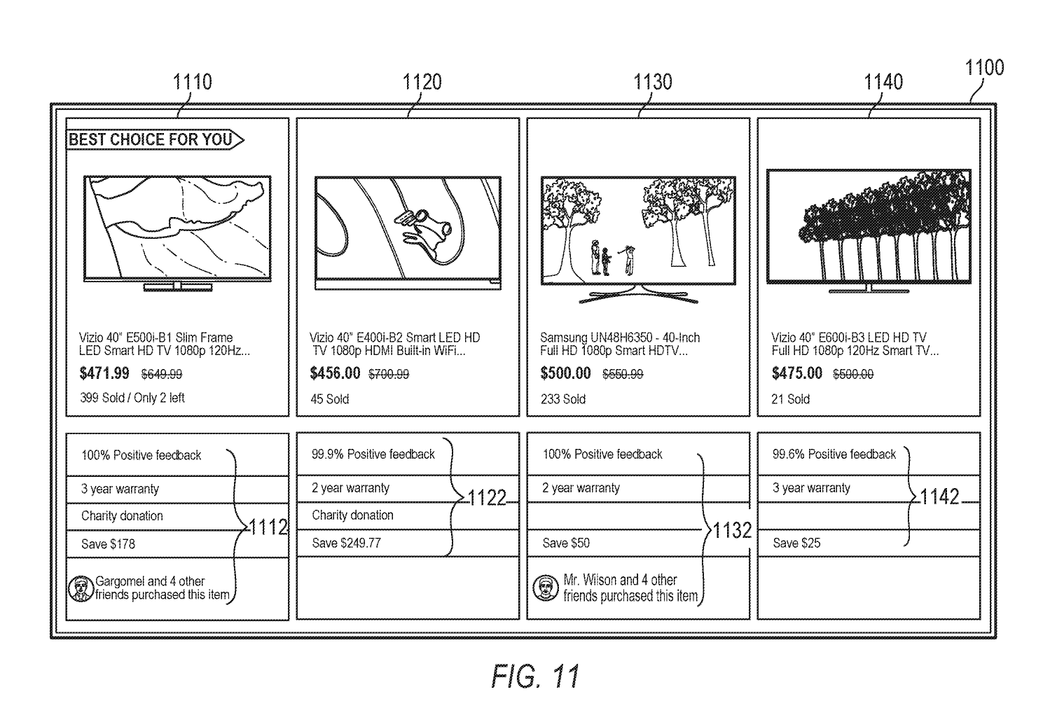

FIG. 11 illustrates a UI 1100 displaying multiple item listings 1110, 1120, 1130, and 1140 with features 1112, 1122, 1132, and 1142, respectively, in accordance with some example embodiments. Similar to the example embodiments of FIG. 10, in FIG. 11, the features determined to be the most unique for each item listing, as well as the features determined to be the most relevant to the user, are highlighted (e.g., displayed in bold, as opposed to a lighter shade). User information, such as past user activity (e.g., the user donating to a charity) and activity of social media connections (e.g., friends of the user having purchased an item), can be used to determine the relevance and uniqueness of a feature.

In some example embodiments, the feature highlighting module 530 is configured to cause an indication for why a feature is being highlighted to be displayed to the user. For example, the highlighted feature can include an explanation of why it is relevant to the user (e.g., “proceeds from the sale of this item will go to the same charity that you have donated to in the past”).

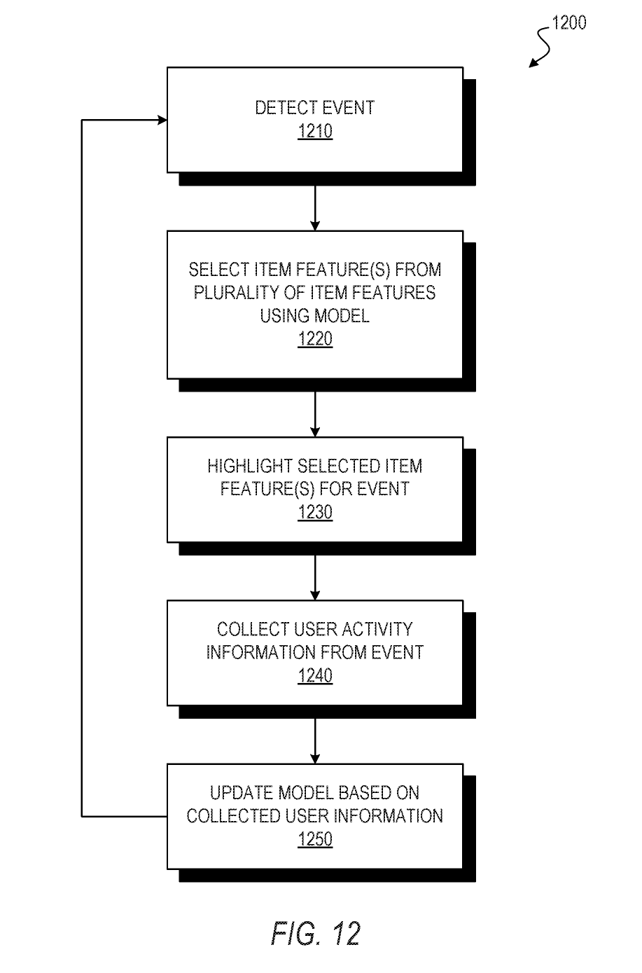

FIG. 12 is a flowchart illustrating a method 1200 of highlighting features of an item listing, in accordance with some example embodiments. The operations of method 1200 can be performed by a system or modules of a system. The operations of method 1200 can be performed by processing logic that can comprise hardware (e.g., circuitry, dedicated logic, programmable logic, microcode, etc.), software (e.g., instructions run on a processing device), or a combination thereof. In one example embodiment, the method 1200 is performed by feature highlighting system 150 of FIGS. 1, 4, and 5, or any combination of one or more of its components or modules, as described above.

At operation 1210, an event involving one or more item listings (or an event involving online content of another type) is detected or otherwise determined, as previously discussed. In some example embodiments, the event comprises a request to display the one or more item listings (or other online content) on a computing device of a user (e.g. a click by the user on a selectable graphical user interface element to trigger a search).

At operation 1220, for each one of the one or more item listings, one or more features are selected from a plurality of potential features of the corresponding item listing using a model based on any combination of one or more of user information, item information, and feature constraints, as previously discussed. In some example embodiments, the selecting of the feature(s) from the plurality of features is further based on a degree of variance between the selected feature(s) and a corresponding at least one feature of at least one item listing other than the first item listing, with the corresponding feature(s) being of the same type as the selected feature(s).

At operation 1230, the selected feature(s) are caused to be highlighted, as previously discussed. In some example embodiments, the selected feature(s) of each of the one or more item listings is caused to be highlighted in a display of the item listing on the computing device based on the selecting of the feature(s). The highlighting of the selected feature(s) may comprise displaying the selected feature(s) instead of the unselected ones of the plurality of features. The highlighting of the selected feature(s) may comprise applying a visual effect to the selected feature(s), with the application of the visual effect being distinct from a presentation of the unselected ones of the plurality of features. In some example embodiments, the selecting of the feature(s) from the plurality of features comprises determining corresponding scores for each of the plurality of features using the model, ranking the plurality of features based on their corresponding scores, and selecting the at least one feature based on the ranking. The selection of the at least one feature based on the ranking may comprise selecting only features having a score that satisfies a predetermined threshold (e.g., only features having a corresponding score that meets or exceeds a specified minimum score). The selection of the at least one feature based on the ranking may additionally or alternatively comprise selecting the a specified number of the highest or lowest ranked features (e.g., selecting the top three ranked features for an item listing).

At operation 1240, user activity information is collected, as previously discussed. In some example embodiments, user activity information indicating at least one action performed for the first item listing by the user is received, with the action(s) corresponding to the display of the highlighted selected at least one feature (e.g., a purchasing action performed by the user subsequent to and during the same session as the display of the highlighted feature(s) to the user).

At operation 1250, the model used to select the features is updated based on the user activity information, as previously discussed. In some example embodiments, machine learning techniques are employed to reconfigure the model based on the user activity information.

It is contemplated that the operations of method 1200 can incorporate any of the other features disclosed herein.

It is contemplated that any features of any embodiments disclosed herein can be combined with any other features of any other embodiments disclosed herein. Accordingly, these any such hybrid embodiments are within the scope of the present disclosure.

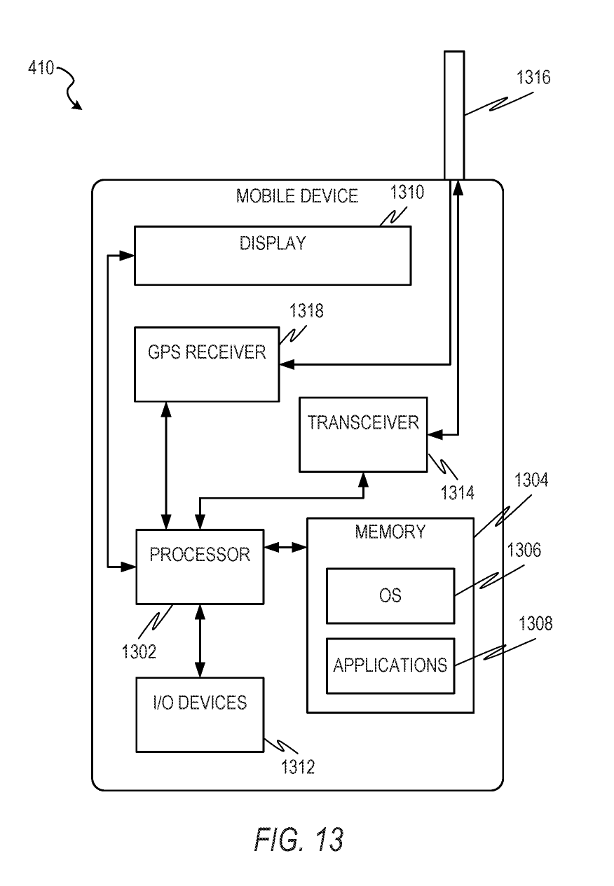

FIG. 13 is a block diagram illustrating a mobile device 410, in accordance with some example embodiments. The mobile device 410 can include a processor 1302. The processor 1302 can be any of a variety of different types of commercially available processors suitable for mobile devices 410 (for example, an XScale architecture microprocessor, a Microprocessor without Interlocked Pipeline Stages (MIPS) architecture processor, or another type of processor). A memory 1304, such as a random access memory (RAM), a Flash memory, or other type of memory, is typically accessible to the processor 1302. The memory 1304 can be adapted to store an operating system (OS) 1306, as well as application programs 1308, such as a mobile location enabled application that can provide LBSs to a user. The processor 1302 can be coupled, either directly or via appropriate intermediary hardware, to a display 1310 and to one or more input/output (I/O) devices 1312, such as a keypad, a touch panel sensor, a microphone, and the like. Similarly, in some example embodiments, the processor 1302 can be coupled to a transceiver 1314 that interfaces with an antenna 1316. The transceiver 1314 can be configured to both transmit and receive cellular network signals, wireless data signals, or other types of signals via the antenna 1316, depending on the nature of the mobile device 410. Further, in some configurations, a GPS receiver 1318 can also make use of the antenna 1316 to receive GPS signals.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 5-12 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the features of the present disclosure in different contexts from the disclosure contained herein.

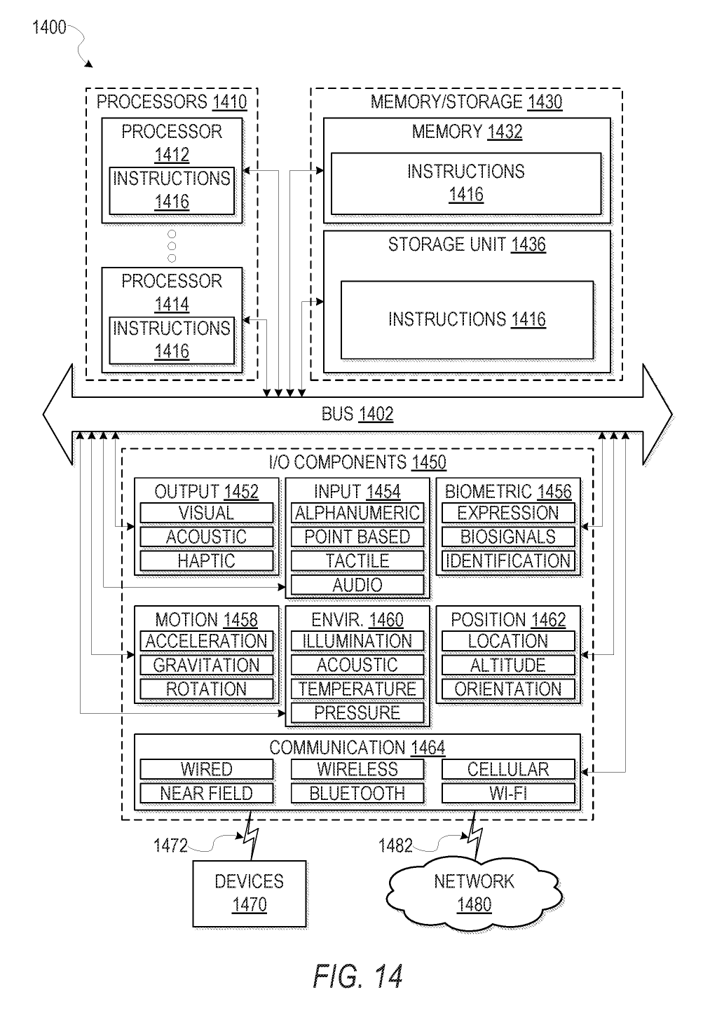

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1416 (e.g., software, a program, an application, an applet, an app, or other executable code) for causing the machine 1400 to perform any one or more of the methodologies discussed herein may be executed. For example the instructions may cause the machine to execute the flow diagrams of FIGS. 11-14. Additionally, or alternatively, the instructions may implement the outage detection module 410, the listing identification module 420, and the management action module 430 of FIG. 4, and so forth. The instructions transform the general, non-programmed machine into a particular machine programmed to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 may include processors 1410, memory 1430, and I/O components 1450, which may be configured to communicate with each other such as via a bus 1402. In an example embodiment, the processors 1410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1412 and processor 1414 that may execute instructions 1416. The term “processor” is intended to include multi-core processor that may comprise two or more independent processors (sometimes referred to as “cores”) that may execute instructions contemporaneously. Although FIG. 14 shows multiple processors, the machine 1400 may include a single processor with a single core, a single processor with multiple cores (e.g., a multi-core process), multiple processors with a single core, multiple processors with multiples cores, or any combination thereof.

The memory/storage 1430 may include a memory 1432, such as a main memory, or other memory storage, and a storage unit 1436, both accessible to the processors 1410 such as via the bus 1402. The storage unit 1436 and memory 1432 store the instructions 1416 embodying any one or more of the methodologies or functions described herein. The instructions 1416 may also reside, completely or partially, within the memory 1432, within the storage unit 1436, within at least one of the processors 1410 (e.g., within the processor's cache memory), or any suitable combination thereof, during execution thereof by the machine 1400. Accordingly, the memory 1432, the storage unit 1436, and the memory of processors 1410 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1416. The term “machine-readable medium” shall also be taken to include any medium, or combination of multiple media, that is capable of storing instructions (e.g., instructions 1416) for execution by a machine (e.g., machine 1400), such that the instructions, when executed by one or more processors of the machine 1400 (e.g., processors 1410), cause the machine 1400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1450 may include a wide variety of components to receive input, provide output, produce output, transmit information, exchange information, capture measurements, and so on. The specific I/O components 1450 that are included in a particular machine will depend on the type of machine. For example, portable machines such as mobile phones will likely include a touch input device or other such input mechanisms, while a headless server machine will likely not include such a touch input device. It will be appreciated that the I/O components 1450 may include many other components that are not shown in FIG. 14. The I/O components 1450 are grouped according to functionality merely for simplifying the following discussion and the grouping is in no way limiting. In various example embodiments, the I/O components 1450 may include output components 1452 and input components 1454. The output components 1452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1450 may include biometric components 1456, motion components 1458, environmental components 1460, or position components 1462 among a wide array of other components. For example, the biometric components 1456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1458 may include acceleration sensor components (e.g., accelerometer), gravitation sensor components, rotation sensor components (e.g., gyroscope), and so forth. The environmental components 1460 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 or devices 1470 via coupling 1482 and coupling 1472 respectively. For example, the communication components 1464 may include a network interface component or other suitable device to interface with the network 1480. In further examples, communication components 1464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1470 may be another machine or any of a wide variety of peripheral devices (e.g., a peripheral device coupled via a Universal Serial Bus (USB)).

Moreover, the communication components 1464 may detect identifiers or include components operable to detect identifiers. For example, the communication components 1464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1464, such as, location via Internet Protocol (IP) geo-location, location via Wi-Fi® signal triangulation, location via detecting a NFC beacon signal that may indicate a particular location, and so forth.

In various example embodiments, one or more portions of the network 1480 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1480 or a portion of the network 1480 may include a wireless or cellular network and the coupling 1482 may be a Code Division Multiple Access (CDMA) connection, a Global System for Mobile communications (GSM) connection, or other type of cellular or wireless coupling. In this example, the coupling 1482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1416 may be transmitted or received over the network 1480 using a transmission medium via a network interface device (e.g., a network interface component included in the communication components 1464) and utilizing any one of a number of well-known transfer protocols (e.g., hypertext transfer protocol (HTTP)). Similarly, the instructions 1416 may be transmitted or received using a transmission medium via the coupling 1472 (e.g., a peer-to-peer coupling) to devices 1470. The term “transmission medium” shall be taken to include any intangible medium that is capable of storing, encoding, or carrying instructions 1416 for execution by the machine 1400, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor; and
a non-transitory computer-readable medium storing executable instructions that, when executed, cause the at least one processor to perform operations comprising:
detecting a request to display a first item listing on a computing device of a user, the first item listing having a plurality of features;
selecting at least one feature from the plurality of features based on user information associated with the user, in response to the detecting the request; and
causing, based on the selecting at least one feature, the selected at least one feature to be highlighted in a display of the first item listing on the computing device, the highlighting of the selected at least one feature comprising at least one of displaying the selected at least one feature instead of the unselected ones of the plurality of features and applying a visual effect to the selected at least one feature, the application of the visual effect being distinct from a presentation of the unselected ones of the plurality of features.

2. The system of claim 1, wherein the highlighting of the selected at least one feature comprises applying the visual effect to the selected at least one feature, the visual effect comprising at least one of a distinct color, a distinct font, a distinct boldness level, a rectangular graphical element, and a circular graphical element.

3. The system of claim 1, wherein the user information comprises at least one of a geographic location of the user, an age of the user, a gender of the user, a browsing history of the user, a purchasing history of the user, and a purchasing funnel position corresponding to the request to display the first item listing.

4. The system of claim 1, wherein the selecting the at least one feature from the plurality of features is further based on a degree of variance between the selected at least one feature and a corresponding at least one feature of at least one item listing other than the first item listing, the corresponding at least one feature being of the same type as the selected at least one feature.

5. The system of claim 4, wherein the at least one item listing other than the first item listing is displayed on the computing device concurrently with the first item listing being displayed on the computing device with the selected at least one feature highlighted.

6. The system of claim 5, wherein the at least one item listing other than the first item listing and the first item listing are displayed concurrently on a search results page of an online service.

7. The system of claim 5, wherein the at least one item listing other than the first item listing and the first item listing are displayed concurrently in an e-mail message or in a web widget.

8. The system of claim 1, wherein the selecting the at least one feature from the plurality of features comprises:
determining corresponding scores for each of the plurality of features using a model;
ranking the plurality of features based on their corresponding scores; and
selecting the at least one feature based on the ranking.

9. The system of claim 8, wherein the operations further comprise:
receiving user activity information indicating at least one action performed for the first item listing by the user, the at least one action corresponding to the display of the highlighted selected at least one feature; and
updating the model based on the received user activity information.

10. A computer-implemented method comprising:
detecting a request to display a first item listing on a computing device of a user, the first item listing having a plurality of features;
selecting, by at least one processor, at least one feature from the plurality of features based on user information associated with the user, in response to the detecting the request; and
causing, based on the selecting at least one feature, the selected at least one feature to be highlighted in a display of the first item listing on the computing device, the highlighting of the selected at least one feature comprising at least one of displaying the selected at least one feature instead of the unselected ones of the plurality of features and applying a visual effect to the selected at least one feature, the application of the visual effect being distinct from a presentation of the unselected ones of the plurality of features.

11. The computer-implemented method of claim 10, wherein the highlighting of the selected at least one feature comprises applying the visual effect to the selected at least one feature, the visual effect comprising at least one of a distinct color, a distinct font, a distinct boldness level, a rectangular graphical element, and a circular graphical element.

12. The computer-implemented method of claim 10, wherein the user information comprises at least one of a geographic location of the user, an age of the user, a gender of the user, a browsing history of the user, a purchasing history of the user, and a purchasing funnel position corresponding to the request to display the first item listing.

13. The computer-implemented method of claim 10, wherein the selecting the at least one feature from the plurality of features is further based on a degree of variance between the selected at least one feature and a corresponding at least one feature of at least one item listing other than the first item listing, the corresponding at least one feature being of the same type as the selected at least one feature.

14. The computer-implemented method of claim 13, wherein the at least one item listing other than the first item listing is displayed on the computing device concurrently with the first item listing being displayed on the computing device with the selected at least one feature highlighted.

15. The computer-implemented method of claim 14, wherein the at least one item listing other than the first item listing and the first item listing are displayed concurrently on a search results page of an online service.

16. The computer-implemented method of claim 10, wherein the selecting the at least one feature from the plurality of features comprises:
determining corresponding scores for each of the plurality of features using a model;
ranking the plurality of features based on their corresponding scores; and
selecting the at least one feature based on the ranking.

17. The computer-implemented method of claim 16, further comprising:
receiving user activity information indicating at least one action performed for the first item listing by the user, the at least one action corresponding to the display of the highlighted selected at least one feature; and
updating the model based on the received user activity information.

18. A non-transitory machine-readable storage medium storing a set of instructions that, when executed by at least one processor, causes the at least one processor to perform operations comprising:
detecting a request to display a first item listing on a computing device of a user, the first item listing having a plurality of features;
selecting at least one feature from the plurality of features based on user information associated with the user, in response to the detecting the request; and
causing, based on the selecting at least one feature, the selected at least one feature to be highlighted in a display of the first item listing on the computing device, the highlighting of the selected at least one feature comprising at least one of displaying the selected at least one feature instead of the unselected ones of the plurality of features and applying a visual effect to the selected at least one feature, the application of the visual effect being distinct from a presentation of the unselected ones of the plurality of features.

19. The storage medium of claim 18, wherein the highlighting of the selected at least one feature comprises applying the visual effect to the selected at least one feature, the visual effect comprising at least one of a distinct color, a distinct font, a distinct boldness level, a rectangular graphical element, and a circular graphical element.

20. The storage medium of claim 18, wherein the user information comprises at least one of a geographic location of the user, an age of the user, a gender of the user, a browsing history of the user, a purchasing history of the user, and a purchasing funnel position corresponding to the request to display the first item listing.
